(19) United States
(12) Patent Application Publication
(10) Pub. No.: US 2023/0046494 A1
(43) Pub. Date: Feb. 16, 2023

(54) SYSTEMS AND METHODS FOR MARKET VALUE AT RISK EVALUATION

(71) Applicant: JPMorgan Chase Bank, N.A., New York, NY (US)

(72) Inventors: Vadim TSUKHTMAN, Bronx, NY (US); Hiang Swee CHIANG, Scarsdale, NY (US); Hari MOORTHY, West Windsor, NJ (US); Viktor VOROSHYLO, Kew Gardens, NY (US); Bolei GUO, Stamford, CT (US); Jonathan Koop, Brooklyn, NY (US)

(21) Appl. No.: 15/261,350

(22) Filed: Sep. 9, 2016

(51) Int. Cl. G06Q 10/06; G06Q 30/02

(52) U.S. Cl. CPC G06Q 10/0635; G06Q 30/0201

(57) ABSTRACT

Systems and methods for market value at risk evaluation are disclosed. In one embodiment, a method for performing a calculation workflow may include (1) a server comprising a computer processor receiving a request for a calculation; (2) the server receiving at least one data parameter; (3) the server identifying a plurality of workflow components required for the calculation; (4) the server identifying dependencies for each identified workflow component; (5) the server ordering the identified workflow components based on the dependencies for each workflow component; (6) the server retrieving data to conduct the calculation; and (7) the server performing the requested calculation using the ordered workflow components based on the data parameter and the data.

### BACKGROUND OF THE INVENTION

### 1. Field of the Invention

The present invention generally relates to systems and methods for market value at risk evaluation.

### 2. Description of the Related Art

Value at Risk, or “VaR” is a statistical technique used to forecast an expected worst loss (at a specified probability) for a financial institution for a portfolio's distribution of market returns, based on a specific historical look back period. Stress is a scenario-based technique used to identify a predicted worst loss based on a set of scenarios defined to capture low probability events that may not have occurred in the historical market returns population. Market Risk pricing models are used to compute market returns. These pricing models may be variants of the Front Office pricing models or models specifically built for the market risk purposes.

Both VaR and stress calculations rely on market and reference data such as spot and historical prices, product attributes, ratings, etc. They are also commonly used by firms to measure and manage risk as well as by the regulators of the financial industry in order to compare financial institutions risk exposure and ensure that they are adequately capitalized.

### SUMMARY OF THE INVENTION

Systems and methods for market value at risk evaluation are disclosed. In one embodiment, a method for performing a calculation workflow may include (1) a server comprising a computer processor receiving a request for a calculation; (2) the server receiving at least one data parameter; (3) the server identifying a plurality of workflow components required for the calculation; (4) the server identifying dependencies for each identified workflow component; (5) the server ordering the identified workflow components based on the dependencies for each workflow component; (6) the server retrieving data to conduct the calculation; and (7) the server performing the requested calculation using the ordered workflow components based on the data parameter and the data.

In one embodiment, the data and/or the result of the calculation may be made available for reporting and/or consumption.

In one embodiment, the data may include front office data that is retrieved from a front office system.

In one embodiment, the data parameter may include a proxy, a tenor point, a scenario, a data source for the data, a shock, and/or a stress.

In one embodiment, the workflow components may include some or all of a positions component, an instrument component, an exposure component, a proxy component, a, stress component, a shock component, a scenario component, and a priceable component.

According to another embodiment, a method for performing a calculation workflow may include: (1) a server comprising a computer processor receiving a request for a calculation based on a start value; (2) the server receiving at least one data parameter; (3) the server identifying a plurality of workflow components required for the calculation; (4) the server identifying dependencies for each identified workflow component; (5) the server ordering the identified workflow components based on the dependencies for each workflow component; (6) the server identifying a workflow component associated with the start value; (7) the server retrieving data to conduct the calculation; and (8) the server performing the requested calculation by providing the start value as an input to a workflow component that follows the identified workflow component based on the data parameter and the data.

In one embodiment, the data may include front office data that is retrieved from a front office system.

In one embodiment, the data parameter may include a proxy, a time, a scenario, a data source for the data, a shock, and/or a stress.

In one embodiment, the workflow components may include some or all of a positions component, an instrument component, an exposure component, a proxy component, a, stress component, a shock component, a scenario component, and a priceable component.

In one embodiment, the method may further comprise adjusting the data parameter.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for market value at risk evaluation according to one embodiment;

FIG. 2 depicts a workflow for market value at risk evaluation according to one embodiment; and

FIG. 3 depicts a dynamic workflow component configuration according to one embodiment.

### DETAILED DESCRIPTION OF PREFERRED EMBODIMENTS

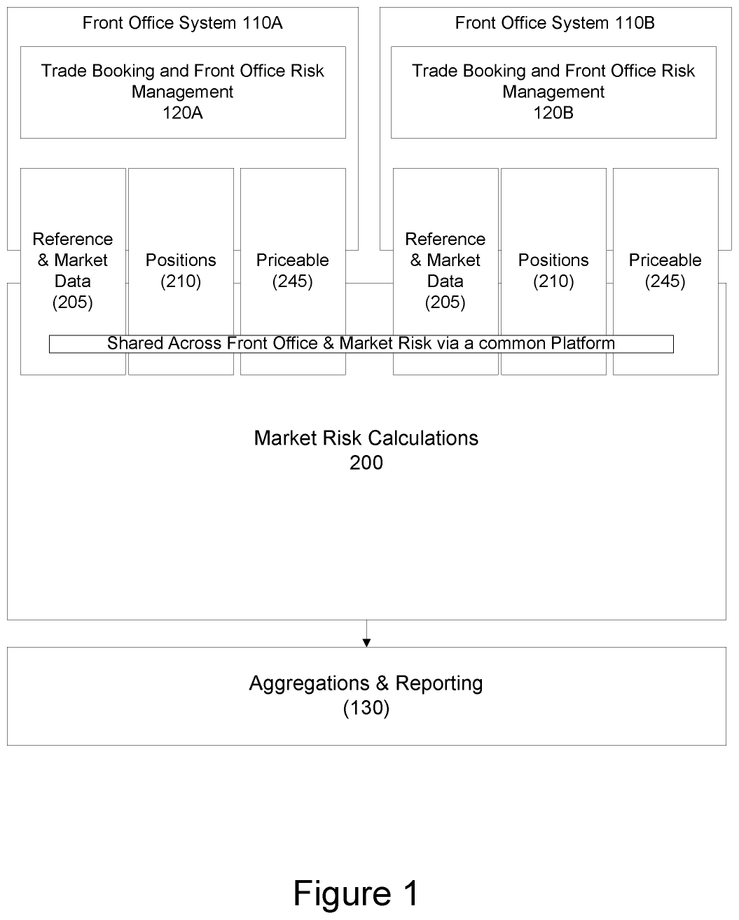

Several embodiments of the present invention and their advantages may be understood by referring to FIGS. 1-3.

Embodiments disclosed herein may provide some or all of the following: (1) the use of actual Front Office pricing models for market risk pricing in on a centralized platform; (2) the use of Front Office market data/centralized reference data and ability to switch data sources; (3) the use of plug and play interchangeable components to support both model development and production methodologies; (4) a common environment that may be shared by multiple technology and quantitative research (“QR”) teams; (5) quick time to market leveraging previously developed components/methodologies; (6) serves as a vehicle for standardizing potentially disparate methodologies across a financial institution or other entity; (7) provides quick standardized development environment setup for both QR and Technology users; (8) allows easy to support for multiple “what if?”/test environments, supports checkouts of time series scrub results; (9) drives standardization of reference data for both VaR and Stress across a financial institution or other entity.

The type of pricing models implementation that may be used for calculations is important in producing accurate VaR and stress results. The ability to use Front Office pricing models, instead of approximations therefore, greatly enhances the accuracy and predictive capacity of the calculations.

In one embodiment, standardized market and reference data are important in ensuring consistent and accurate VaR and stress results across a financial institution. The complexity of providing an effective solution is an attribute of the number and type of financial instruments (for example, multiple front office systems maintaining similar market/reference data for similar products), as well as the large number of Front Office/risk systems, market/reference data systems, as well as the Front Office Risk calculations for these instruments.

The calculations involved in producing VaR and stress are generally performed across upstream systems (mainly for “Full Revaluation,” or “Full Reval” calculations using Front Office models) and in a central Market Risk system (mainly using “sensitivity-based” VaR approximations developed by Market Risk QR).

Embodiments are directed to market VaR evaluation. In one embodiment, an application framework may centralize VaR and stress calculations on a common platform that allows the use of common models, market and reference data and facilitates close collaboration across Front Office and Market Risk QR and Technology teams.

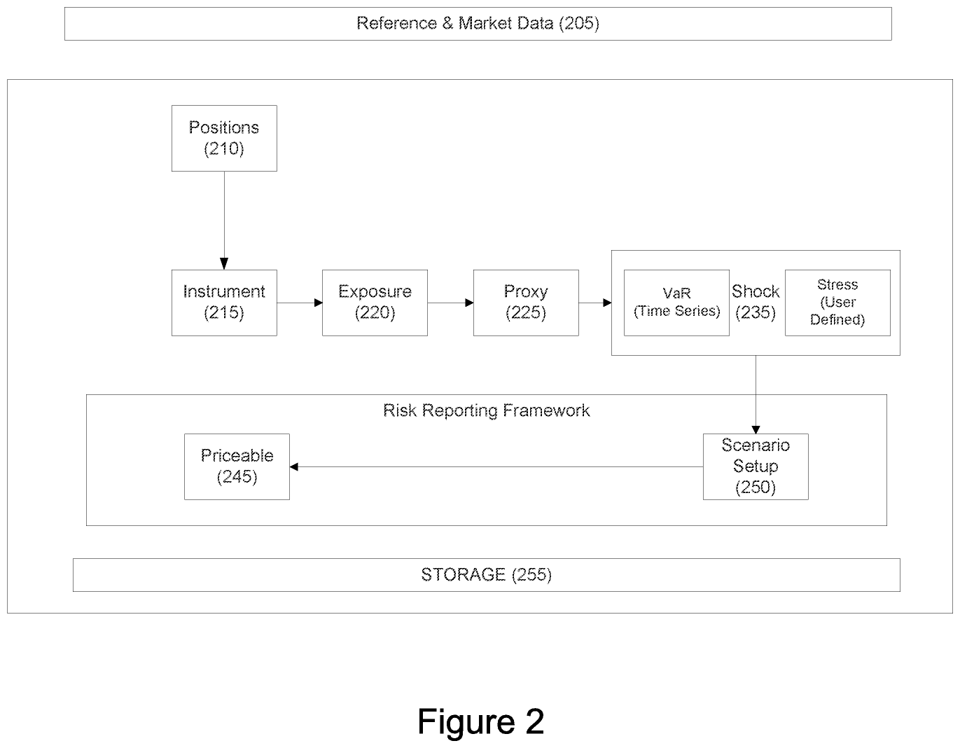

Referring to FIGS. 1 and 2, a system for market value at risk evaluation and a workflow are disclosed according to one embodiment. In one embodiment, system 100 may include Front Office System 110A, Front Office System 110B, etc. The number of Front Office Systems 110 that may be incorporated may be determined as is necessary and/or desired.

Each Front Office System 110 may include Trade Booking And Front Office Risk Management 120A, 120B, etc. For example, Trade Booking is where trades may be captured and live. After trades are captured, they may undergo lifecycle events through termination (e.g., expiration).

Risk Management is where these trades are priced/evaluated for risk purposes. A Front Office risk management system may, for example, implement the pricing algorithm and calculate coefficients to be used in “sensitivity-based” VaR approximations.

System 100 may further include market risk calculation components 200, and aggregations and reporting components 130. Aggregations permit the risk to be seen at each level of an organization, such as at the account level, at the portfolio level, at the desk level, etc.

Reporting may be permanent reporting, or may be ad-hoc reporting (e.g., for regulators) that may be built for the data, front office platform, etc.

Market Risk may comprise a superset of data (e.g., broader than organizational risk).

Referring to FIG. 2, a workflow for market risk calculations 200 is disclosed according to one embodiment. At a high level, the workflow may include a calculation workflow that drives execution of the calculation through the individual components of the workflow. The workflow components may be used for a variety of tasks, including for example sourcing positions, identifying exposures and corresponding time series, sourcing reference and market data, generating shocks, producing the profit and loss (“PnL”) vectors that are fed to the risk aggregator, etc.

In one embodiment, each component may be individually configurable and executable, and may have specific dependencies. Thus, the components may be arranged based on their dependencies.

In one embodiment, a workflow may select from some or all of the following components: Positions component 210 that may retrieve the trade/position population; Instrument component 215 that may define an instrument that will be used to price the trade/position; Exposure component 220 that may determine the risks exposures of the instrument; Proxy component 225, which is used for VaR, and may identify which Time Series 230 to use for the calculations; Shock component 235 that may generate a shock (model input prices based on time series returns/scenario returns) from time series sources or stress scenarios; Stress component 240, which is used for stress, and may define Stress scenarios to be applied to positions; Scenario Setup component 245 that may create instrument and pricer specific scenarios; and Priceable component 250 that may apply one or more scenario to a priceable instrument.

In one embodiment, Positions component 210 may retrieve a collection of identifiers that may be used to identify the population of unique instruments (e.g., a list of International Securities Identification Numbers, or ISINs). This population may be filtered so that it is compatible with some or all calculations, so that no further filtering is needed downstream in the calculation workflow. In one embodiment, position information may be provided prior to the calculation workflow, and Positions component 210 may store the position information in a database.

In one embodiment, Instrument component 215 may form a container object that may be used to price, report exposures, and react to, for example, changes in data parameters. This object may be understood by downstream Application Programmable Interfaces (“APIs”) in risk reporting frameworks and may be used in the calculation framework to compute changes in price due to shifting the market by applying scenarios.

In one embodiment, the instruments may include native instrument objects that represent a contract that has been traded, PnL Predict Instruments that use front office sensitivities to scale linearly to shocks, analytics containers that encapsulate required analytics library operations or Market Risk QR Model instruments, such as replicated Multivariate Adaptive Regression Splines (“MaRRS”) regression calculator, etc.

In one embodiment, Instrument component 215 may include market risk sensitivity mappings as well as position to instrument mappings where positions are not native to the risk reporting framework.

In one embodiment, Instrument component 215 may retrieve front office calculations and apply those calculations within the market risk framework.

In one embodiment, Instrument component 215 may perform a full reroute calculation. For example, to calculate VaR returns for Market Risk, the exact front office pricing model is run. This may yield a precise number, which is not possible to achieve when running sensitivity-based VaR calculations, especially for non-linear instruments and results in a higher quality VaR numbers reported by the firm.

In one embodiment, instrument component 215 may provide a “cannot predict” indicator may be provided, and may provide an approximation.

In one embodiment, a very accurate, but very expensive, time consuming, etc. number may be provided, and/or a less accurate, but cheaper and faster, approximation may be provided.

Other models with varying accuracy and/or expense/time requirements may be used as is necessary and/or desired.

In one embodiment, Exposure component 220 may identify market dependency risk factors associated with the instruments in the position population. For example, for full revaluation calculations on instruments sourced from the risk reporting framework, these market dependencies may be determined by inspecting the dependencies involved in computing a unit price (e.g., in U.S. dollars) of the instrument using the market model. For sensitivity-based calculations, position identifiers and sensitivities may be delivered together by upstream feeds, and Exposure component 220 may normalize the representation from the feed dataset.

Other analytics frameworks may be used to source this information when pricing using those models.

In addition to the risk factors, Exposure component 220 may map risk factors to market data for instruments that are not native to the risk reporting framework.

In one embodiment, Exposure component 220 may select the inputs that are required for the specific calculation, the risk factors for the instrument that is being priced, etc. In order perform a calculation, a set of inputs is identified.

In one embodiment, Proxy component 225 may inspect exposures identified by Exposure component 220 and may identify the time series for one or more of those exposures. In one embodiment, the exposures may be used to select the time series that may be used as an input for calculating shocks for VaR. In one embodiment, Proxy component 225 may use a proxy waterfall model to identify one or more alternate time series if the data for a particular time series is deemed unsuitable (e.g., it is incomplete for the time period that is used, illiquid, etc.).

In one embodiment, Proxy component 225 may identify a proxy for a financial product (e.g., a stock, an index, etc.).

In one embodiment, because time series are not used for stress calculations, the proxy component is not part of a calculation workflow for stress calculations.

In one embodiment, Shock component 235 may use the output of Exposure component 220 and, where applicable Proxy component 225, and may compute a series of relative and absolute shock levels. The relative (percentage) or absolute (basis) shock may be determined based on the type of exposure being shocked, and the methodology, which may be risk-factor based. In one embodiment, for VaR calculations, the shock levels may be based upon the time series and proxy rules. For stress calculations, scenario definitions may be applied against risk factor central market and reference data 205 to compute shock levels.

Scenario Setup component 245 may form scenario objects that may be interpreted by the risk reporting framework to apply shocks into the market model. The scenario objects may be asset class and pricer specific. Scenario Setup component 345 may also sanitize the shocks to avoid calibration failures in the resultant shocked market data.

In one embodiment, Scenario Setup component 245 may build a risk model from scenario objects and may compute scenario PnL values for each priceable object using the risk reporting framework. The risk reporting framework may group priceable objects based on common market dependencies and/or any other information to optimize performance when calculating remotely in the computation grid. Priceable component 250 may return unit level PnL results per instrument per scenario as well as any related diagnostic information as necessary and/or desired.

In one embodiment, Priceable component 250 may be a Market Risk priceable and/or a Front Office priceable, using either Front Office or centralized Market Risk market/reference data, that may allow the workflow to use the exact front office methodology for Full Reval VaR and Stress calculations. In one embodiment, Priceable component 250 may provide standardization across a financial institution as necessary and/or desired.

In one embodiment, some or all of the components identified above allow for independent development/maintenance by, for example, both Front Office and Market Risk QR technology teams.

In one embodiment, having some or all of the components listed above centralized in one place allows for easy comparison across models and for impact analysis of changes to any of the components, such as Proxy component 225, or any of the data that the component uses, such as Time Series data.

In one embodiment, the workflow may be built on any suitable risk reporting framework.

In one embodiment, the workflow may perform several different calculation workflows that may be defined by the type of calculation, the source of the positions, and the type of instruments. The various calculation workflows may share a similar set of workflow components, and may include or lack certain components depending upon the requirements of the calculation being performed. For example, stress calculation workflows may not include proxy and time series components.

There may also be different implementations of the same component due to the nature of the calculation and/or positions. For example, VaR calculations may use a shock component which sources shock levels from time series, while stress calculations may use a shock component from a stress scenario specification.

A workflow component may encapsulate the functionality to execute a stage of the calculation workflow. In one embodiment, a workflow component may declare its dependencies in terms of other workflow components that precede it, and may implement a run method that takes the output of its dependency workflow components as its input. There are some components with zero dependencies (as will always be the case with the first component in the workflow) that will contain a run method which takes no arguments.

In one embodiment, a workflow runner may be responsible for executing a portion or the entirety of a calculation workflow. The workflow looks at the last state of the workflow and computes a dependency tree of all of the components needed in order to execute and produce a result. The workflow runner may flatten the dependency tree into an ordered list of components that may be called serially to execute the overall workflow calculation.

While executing serially, the workflow runner may obtain the results of dependencies for each service, and may pass those to the run method of the service it wants to execute. In one embodiment, the dependency tree may not contain circular dependencies between workflow components.

In one embodiment, the workflow runner may integrate with a dependency manager for the platform. A calculation workflow may be defined so that the entire workflow may be run within a single job, or alternatively divided so that sections of the workflow run in separate jobs. To accomplish this, the workflow configuration may define a list of division points in the workflow. The division points may then be applied against the flattened list of components derived from the dependency tree to obtain a sub-list of components to run in each separate job.

In one embodiment, in a divided workflow, each of the separate jobs may identify the first workflow component that it will execute and source dependency inputs that would have otherwise been stored by running the prior job(s). The dependency inputs may be inspected to ensure that they are suitable/have been generated in an official environment that matches that of the currently running. In one embodiment, if a job contains multiple workflow components, it must re-run each associated component, and may fail if a dependency is missing. The overall flow of jobs may contain other jobs both preceding and following the set generated for the calculation workflow for up/downstream feeds and cutoff snaps.

In one embodiment, the workflow runner may allow for sections of the workflow to be executed in a stand-alone mode with alternate settings and/or source code for the purpose of facilitating debugging and model development. Results produced in this mode may be tagged with information indicating the alternate settings so that they can be differentiated from the other runs. In one embodiment, when a standalone run is not executed from the beginning of the workflow as defined, the user may be required to provide the dependency inputs for the workflow components that will execute. This may be, for example, from storage APIs, manual input, etc.

If a standalone run is not executed from the beginning of the workflow as defined, a user may provide the dependency inputs for the workflow components that will execute using manually constructed data, etc.

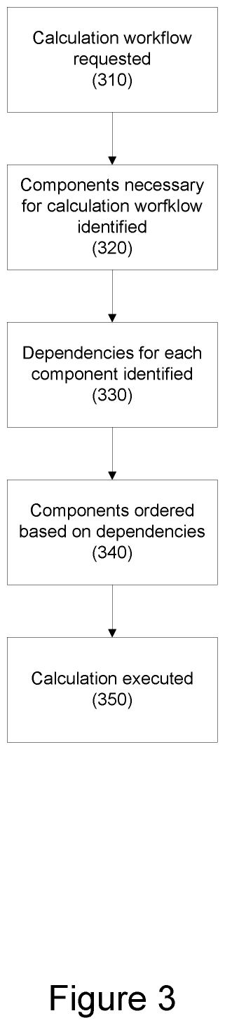

Referring to FIG. 3, a method for dynamic workflow component configuration is disclosed according to one embodiment.

In step 310, a calculation workflow may be requested. In one embodiment, the calculation workflow request may be received at a server.

In one embodiment, the calculation workflow may be a request for stress, VAR, specific risk, and any other suitable risk calculation. In one embodiment, the workflow, and the components involved, will vary depending on the calculation.

In one embodiment, the user may specify conditions for the calculation, such as identifying a proxy, a time, a scenario, etc. as necessary for the requested calculation.

In step 320, the components that are necessary for the calculation workflow may be identified. In one embodiment, the components necessary for each workflow calculation may be pre-defined (e.g., defined by a developer and static); in another embodiment, the components may be selected dynamically. In still another embodiment, given a certain input, such as the output of a component, only the components necessary to complete the calculation may be selected. For example, if the use wishes to determine the impact of an event at the end of a five-component workflow, it may not be necessary to repeat the calculations performed by the first four components. Instead, the output of the fourth component (also the input to the fifth component) may be used, and only the fifth component may be selected.

In step 330, the dependencies for each selected component may be determined. In one embodiment, both the inputs and the outputs for each component may be identified.

In step 340, the components may be ordered based on their dependencies.

In step 350, the calculation may be executed and the output provided to the user. In one embodiment, any necessary data may be retrieved from external sources, such as front office systems.

In one embodiment, the results may be stored. The user may modify parameters as desired and may repeat the calculation, or any part of the calculation, as desired.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for performing a multi-stage calculation workflow, comprising:
a server comprising a computer processor receiving a request to execute a multi-stage market risk calculation workflow comprising a market risk calculation having a calculation type, an output of at least one of the stages of the multi-stage market risk calculation workflow to evaluate, and a front-office pricing model as a source of data for the calculation;
the server dynamically selecting a plurality of predefined workflow components for the multi-stage market risk calculation workflow based on the calculation type, the output to evaluate, and the source of data, wherein each predefined workflow component is individually executable and encapsulates functionality to execute at least one stage of the multi-stage market risk calculation workflow;
the server identifying dependencies for each selected workflow component;
a workflow runner executed by the server generating a dependency tree for the workflow components based on the identified dependencies;
the workflow runner executed by the server flattening the dependency tree into an ordered list of workflow components to be called serially to execute the calculation identified dependencies for the selected workflow components;
the workflow runner executed by the server identifying a plurality of division points in the ordered list of workflow components;
the workflow runner executed by the server separating the ordered list of workflow components into a plurality of jobs each comprising a sub-list of the workflow components based on the division points;
the workflow runner executed by the server ordering the plurality of jobs;
the server retrieving the data from the source of data;
the workflow runner executed by the server running the calculation using the data by calling the plurality of jobs; and
the server storing results of the calculation.

2-10. (canceled)

11. A system for performing a multi-stage calculation workflow, comprising:
a server comprising a computer processor and executing a workflow runner; and
a source for a plurality of workflow components;
wherein:
the server receives a request to execute a multi-stage market risk calculation workflow comprising a calculation having a calculation type and a front-office pricing model as a source of data for the calculation;
the server dynamically selects a plurality of workflow components for the multi-stage market risk calculation workflow based on the calculation type, wherein each workflow component is individually executable and encapsulates functionality to execute at least one stage of the multi-stage market risk calculation workflow;
the server identifies dependencies for each selected workflow component;
the workflow runner generates a dependency tree based on the identified dependencies;
the workflow runner executed by the server flattens the dependency tree into an ordered list of workflow components to be called serially to execute the calculation identified dependencies for the selected workflow components;
the workflow runner executed by the server identifies a plurality of division points in the ordered list of workflow components;
the workflow runner executed by the server separates the ordered list of workflow components into a plurality of jobs each comprising a sub-list of the workflow components based on the division points;
the workflow runner executed by the server orders the plurality of jobs;
the server retrieves the data from the source of data; and
the workflow runner executed by the server runs the calculation using the data by calling the plurality of jobs.

12-20. (canceled)

21. The method of claim 1, wherein one of the workflow components comprises a positions component that retrieves a plurality of trade/positions.

22. The system of claim 11, wherein one of the workflow components comprises a positions component that retrieves a plurality of trade/positions.

23. The method of claim 1, wherein one of the workflow components comprises include an exposure component that determines a risk exposure for the calculation.

24. The method of claim 1, wherein one of the workflow components comprises a proxy component that determines a time series for the calculation.

25. The method of claim 1, wherein one of the workflow components comprises a stress component that defines a stress scenario for the calculation.

26. The method of claim 1, wherein one of the workflow components comprises a shock component that defines a shock for the calculation.

27-28. (canceled)

29. The method of claim 1, wherein the calculation is a stress calculation or a value at risk calculation.

30. The system of claim 11, wherein the server stores results of the calculation.

31. The system of claim 11, wherein one of the workflow components comprises an exposure component that determines a risk exposure for the calculation.

32. The system of claim 11, wherein one of the workflow components comprises a proxy component that determines a time series for the calculation.

33. The system of claim 11, wherein one of the workflow components comprises a stress component that defines a stress scenario for the calculation.

34. The system of claim 11, wherein one of the workflow components comprises a shock component that defines a shock for the calculation.

35-36. (canceled)

37. The system of claim 11, wherein the calculation is a stress calculation or a value at risk calculation.

38. An electronic device, comprising:
a computer processor; and
a workflow runner computer program;
wherein the workflow runner is configured to:
receive a request to execute a multi-stage market risk calculation workflow comprising a calculation having a calculation type, an output of at least one of the stages of the multi-stage market risk calculation workflow to evaluate, and a front-office pricing model as a source of data for the calculation;
dynamically select a plurality of workflow components for the multi-stage market risk calculation workflow based on the calculation type the output to evaluate, and the source of data, wherein each workflow component is individually executable and encapsulates functionality to execute at least one stage of the multi-stage market risk calculation workflow;
identify dependencies for each selected workflow component;
generate a dependency tree for the workflow components based on the identified dependencies;
flatten the dependency tree into an ordered list of workflow components to be called serially to execute the calculation identified dependencies for the selected workflow components;
identify a plurality of division points in the ordered list of workflow components;
separate the ordered list of workflow components into a plurality of jobs each comprising a sub-list of the workflow components based on the division points;
order the plurality of jobs;
retrieve the data from the source of data; and
run the calculation using the data by calling the plurality of jobs.
